(19) United States
(12) Patent Application Publication
(10) Pub. No.: US 2006/0164327 A1
(43) Pub. Date: Jul. 27, 2006

(54) System for lighting an electronic label display

(76) Inventors: Par Rosander, Uppsala (SE); Lars Andersson, Uppsala (SE); Bjorn Nilsson, Jarlasa (SE)

Correspondence Address: JONES DAY, 222 EAST 41ST ST, NEW YORK, NY, 10017, US

(21) Appl. No.: 10/506,120

(22) PCT Filed: Feb. 28, 2003
(86) PCT No.: PCT/SE03/00332

§ 371 Date: Apr. 18, 2005

(30) Foreign Application Priority Data
Feb. 28, 2002 (US) 60359987

(51) Int. Cl. G09G 5/00

(52) U.S. Cl. 345/2.1

(57) ABSTRACT

An electronic label, which is wirelessly connected to a product information updating system, said label comprising at least one display adapted to display product information. The display has a transparent or semitransparent backside and is adapted to be lit up from behind by either an external light source, surrounding main lighting or a built-in light source.

### TECHNICAL FIELD OF THE INVENTION

The present invention relates to an electronic label according to the preamble of claim 1.

It also relates to a product comprising such an electronic label.

### BACKGROUND OF THE INVENTION

Such an electronic price label is described in for example EP 0228377. In an electronic price updating system like this, price labels are attached to for example the shelves in the store or nearby a product bin The price labels comprise components for wireless communication with a price data base. Each time there is a price change for a product this is communicated out to the price label for this product and the price shown on the display in the price label is changed. Normally LCDs are used as displays. Such LCDs have a reflective backside and thus reflects incoming light and provides a visible display.

A problem with this type of price label is that the visibility sometimes is poor in the display.

### SUMMARY

An object of the invention is to provide a label with improved visibility.

This object is achieved in a label according to the preamble of claim 1, having the characterizing features of claim 1.

It is also achieved by a product according to claim 10.

Hereby an electronic label is achieved having a display which can be lit up from behind. This gives a display with good visibility.

Suitably the label comprises at least one descriptive part adapted to be attached to the label, said descriptive part comprising static information about the product, said information being provided outside the area of the display. Hereby a label is achieved that is easy to adapt for different purposes and different products and which also comprises static information that is enlightened from the backside and thus has a good visibility.

Preferably the label is adapted to be lit up from behind by an external light source. Hereby an electronic label is achieved that is lit up from behind and where the light source is separated from the price label. This is preferred since no extra power is required in the label itself for the enlightening.

Further advantageous embodiments of the invention are set out in the dependent claims.

### BRIEF DESCRIPTION OF THE DRAWINGS

FIG. 1 shows a first embodiment of the electronic label according to the invention.

FIG. 2 shows a side view of the embodiment in FIG. 1.

FIG. 3 shows a second embodiment of the electronic label according to the invention.

FIGS. 4a-c show electronic labels according to the invention arranged on a shelf edge rail.

### DETAILED DESCRIPTION OF EMBODIMENTS

According to the invention an electronic label is provided which comprises a display module which is lit up from behind. The display module comprises a display, which could be an LCD or equal, a controller, a memory, power supply, preferably a battery power supply and a communication interface, preferably a wireless communication interface. The display module is adapted to communicate wirelessly with a central product information updating system as described above in the background of the invention. According to the invention the display is provided with a transparent or semitransparent backside for allowing it to be lit up from behind. Suitably it could be a transflective LCD. The other components of the display module are arranged on a printed circuit board which should be located inside the price label but not covering the display since this would prevent the lightening up of the display from behind. Instead of an ordinary printed circuit board a flexible circuit board could be used. This would be suitable since the flexible circuit board would not need much space. It could be coiled up and be placed on one side of the display.

The electronic label is a label showing different information of a product. Often, but not always, the price of the product is included in this information. Therefore the label is called a price label hereafter in this description. However, other information than price could also be shown on the label and be updated from the updating system.

In one embodiment of the invention the price label is adapted to be lit up from behind by surrounding light normally present in the store, main lighting. In another embodiment the price label is adapted to be positioned in front of a light source, which could be for example fluorescent tubes, electro luminescent film or light emitting diodes.

It would be preferred to keep the light source separated from the price label since the light source would require much more power than the price label. Furthermore it is preferred to have a wireless price label system since it is then easier to move the price label together with the merchandises. It is also preferred to not have to change batteries often. If the light source is built into the price label the power consumption would rise much and batteries have to be changed more often or more powerful and bulky batteries are needed.

Suitably the price label has a diffuser layer behind the display which is adapted to let through a certain amount of light. The diffuser can for instance be an opal glass sheet or an opal plastic sheet. The diffuser can also be built up by several layers of plastic, paper or glass material. A transparent backside plate could also be used but a disadvantage is that the light source itself could be seen through the price label if a transparent backside plate is used. A diffuser that is semitransparent would thus be preferred. An alternative solution would be to have a transmittive clear backside of the electronic price label and to have the diffuser layer in connection with the illumination system.

In one preferred embodiment of the invention a transparent sheet with descriptions and/or drawings or photos can be attached to the price label. Suitably this sheet can be attached in front of the display but only having information on the parts not covering the display. Thus the price label area must in this embodiment be larger then the display area, see figs. Since the sheet is transparent it can cover the display without affecting the legibility of the price information much but it is off course also possible to cut out the part of the transparent sheet that otherwise would cover the display. In this case it would also be possible to use an ordinary white paper instead of the transparent sheet for the descriptive part of the price label. The descriptive part could suitably be printed by an ordinary jet printer or laser printer. According to the invention a diffuser should be attached to the backside of the whole price label, comprising both the display and the descriptive sheet. Furthermore the whole price label is adapted to be lit up from behind as described above. Thus both the display and the descriptive part will be lit up and have a good contrast and attractive appearance. It would also be possible to lighten up only the display.

In a store, the price label is located for example in a fruit and vegetable area. The price label displays price on the LCD and item information and possibly also a picture on the descriptive part. The price on the LCD is updated through a wireless interface, that is connected to a processor according to well known techniques for electronic price labeling systems. The LCD could also display other item information such as land of origin.

The descriptive part, which could be printed on a transparent A4 size sheet if that is a suitable size, can easily be changed. It is simply attached in front of a casing of the price label which comprises the display module and the diffuser. Hereby the price label is adaptive to different desires. The information on the descriptive part can easily be changed according to different conditions.

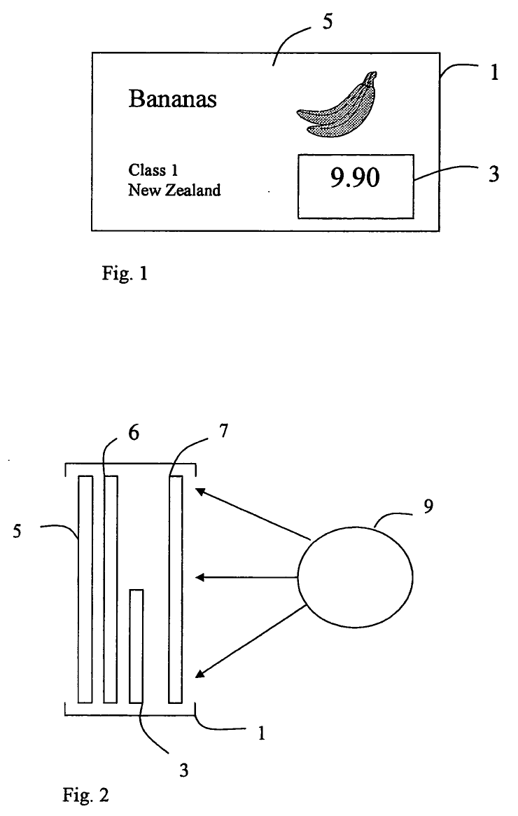

In FIG. 1 a first embodiment of the invention is shown. A casing 1 holds a display module 3 as described above, which in this embodiment comprises an LCD display without a reflective backlayer. In front of the LCD and covering the most of the casing is a transparent sheet 5. On this transparent sheet 5 some information is given. In this example a picture of a banana and the word bananas have been printed on the transparent sheet. Furthermore information about the land of origin and class 1 is given. The descriptive part could suitably be printed in color and include photos or pictures. In this embodiment the price label is adapted to be placed in the fruit and vegetable area and therefore the price label can has a size of for example A4. Then it is convenient to print the descriptive part in an ordinary printer using transparent A4 sheets. Of course the size can be varied. Different price label sizes are preferred in different areas of the store. For example the labels should be much smaller if they should be placed on the shelf edges. In this embodiment the transparent sheet 5, also called the descriptive part 5 covers the LCD 3.

On the backside of the price label in FIG. 1 is a diffuser attached as described above. This diffuser covers the whole backside and is adapted to reflect some of the light and transmit some of the light. Hereby the price label can be lit up from behind. In this example embodiment the price label is adapted to be placed in the fruit and vegetable area. Normally, the lightening is good there and therefore the normal background illumination will be enough for providing a price label with good visibility and attractive appearance. Another possibility is to place the price label in front of a light source. For example many price labels in a row can be placed in front of a fluorescent tube.

If the price label should be placed on the shelf edges in a store or some other place where the surrounding light maybe not is good enough a light source can be provided on the backside of the price label. Preferably a whole row of light sources, e.g. fluorescent tubes or the like are placed along a shelf and then the price labels are simply attached in front of these light sources.

FIG. 2 shows a sideview of the first embodiment of the invention. The same parts are given the same reference numerals as in FIG. 1. Here it is clearly shown that the transparent sheet 5, also called descriptive part, is placed in front of the display module 3 and the diffuser 7. A front cover 6 is also shown. This front cover 6 is adapted to cover the display module 3 and the rest of the area of the price label in order to provide a plane surface for the descriptive part 5 to be attached to. The front cover 6 could be of a transparent material, preferably plexi-glass or glass. Otherwise the front cover 6 could be of a not transparent material, like aluminum, with a hole for the display area. Additional holes must be provided in the cover 6 in order to illuminate the descriptive part 5 or parts of the descriptive part 5.

The casing 1 is more of a frame for keeping the parts together. In this figure the casing 1 is shown in cross section. Furthermore a light source 9 is shown to illuminate the price label from behind.

In another embodiment the descriptive part 5 is instead inserted between the display module 3 and the diffuser 7.

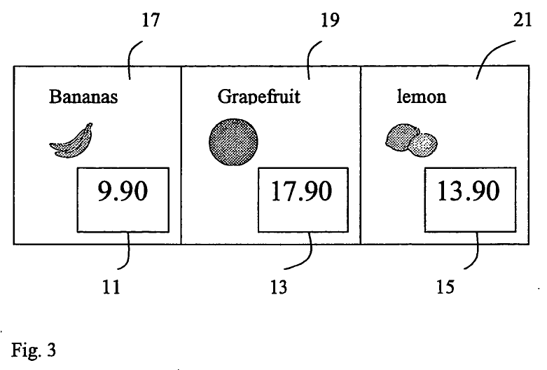

FIG. 3 shows a second embodiment of the invention. Here it is shown that more than one display module can be positioned in the same casing. Three display modules 11, 13, 15 are shown. Furthermore the descriptive parts 17, 19, 21 can be printed on one and the same sheet or separate sheets depending on how big the casing is.

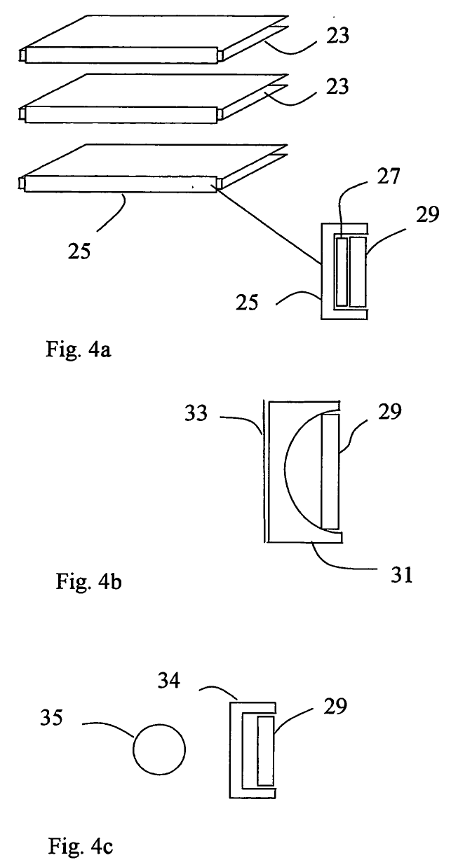

In FIG. 4a an electronic price label arranged on a shelf edge is shown. Three shelf planes 23 are shown. The front side of each shelf plane comprises a shelf edge rail 25. A light source 27 is according to the invention built into or mounted onto the shelf rail. An electronic price label 29 according to the invention is mounted to the rail 25 in front of the light source 27. The light source 27 could be for example electro luminescent film or light emitting diodes.

FIG. 4b shows another variant of an electronic price label according to the invention that is arranged on a shelf edge rail. In this embodiment surrounding main lighting is used for the illumination instead of a built in light source. A shelf edge rail 31 is shown which is designed to act as a light guide. The light guide consists of transparent plastic material that preferably is smooth on all sides except the side closest to the label that can be diffused to direct the light gathered from the surroundings to that side. The profile should preferably be shaped as thicker in the sides were the light shall be received and thinner the further away from these sides to create a uniform illumination behind the price label. On the backside of the rail is a reflector 33 provided. This could be aluminum foil or paper. Surrounding light is reflected and guided such that it illuminates the price label 29 attached to the rail 31.

FIG. 4c shows a further embodiment of an electronic price label 29 according to the invention attached to a shelf edge rail 34. In this embodiment a light source 35 is mounted inside the shelf edge behind the shelf edge rail 34. The shelf edge rail 34 should be in a transmittive, clear color such that the backside of the price label 29 is illuminated. The light source 35 could for example be a fluorescent light tube.

The invention relates also to a product comprising an electronic price label part as described above. The product comprises further a background illumination part, which has fastening means for the price label part. Thus the price label part can easily be removed from the background illumination part and be replaced by another price label part. Hereby only the price label part has to be moved when a product is moved. The illumination part can be left and another price label part can be attached thereto. The price label part has preferably its own power supply, i.e. not the same power supply as the background illumination part. The reason for this is that it is important to keep the power consumption low in the price label part as described above. Another reason is to make it easier to move the price label to another position.

A descriptive part as described above is preferably attached to the price label part. However it can also be attached to the background illumination part.

1. An electronic label, which is wirelessly connected to a product information updating system, said label comprising at least one display adapted to display product information, wherein the display has a transparent or semitransparent backside and is adapted to be lit up from behind.

2. An electronic label according to claim 1, wherein the label comprises at least one descriptive part adapted to be attached to the label, said descriptive part comprising static information about the product, said information being provided outside the area of the display (3).

3. An electronic label according to claim 1, wherein the label is adapted to be lit up from behind by an external light source.

4. An electronic label according to claim 1, wherein the label is adapted to be lit up from behind by surrounding main lighting.

5. An electronic label according to claim 1, wherein the label is adapted to be lit up from behind by a light source mounted behind the label.

6. An electronic label according to claim 1, wherein the label is adapted to be lit up from behind by a built in light source.

7. An electronic label according to claim 1, wherein the label comprises more than one display and is adapted to show information of more than one product.

8. An electronic label according to claim 1, wherein the label comprises a diffuser (7) mounted on the backside.

9. An electronic label according to claim 1, wherein said display (3) is of transflective type, being adapted to both reflect and transmit light.

10. A product comprising an electronic label part according to claim 1 further comprising a background illumination part, wherein the electronic label part has its own power supply.

11. A product according to claim 1, wherein the electronic label part can be readily released from the background illumination part and be replaced by another electronic label part.
